(19) United States
(12) Patent Application Publication
(10) Pub. No.: US 2018/0075500 A1
(43) Pub. Date: Mar. 15, 2018

(54) System and method for collecting and selling the personal contact information of users matched together based upon mutually satisfactory user responses to a survey

(71) Applicants: Kiarash Hamadani, Los Angeles, CA (US); Morvarid Shahbazi Hamadani, Los Angeles, CA (US)

(72) Inventors: Kiarash Hamadani, Los Angeles, CA (US); Morvarid Shahbazi Hamadani, Los Angeles, CA (US)

(21) Appl. No.: 15/261,820

(22) Filed: Sep. 9, 2016

(51) Int. Cl. G06Q 30/06; G06Q 30/02; H04L 12/58

(52) U.S. Cl. CPC G06Q 30/0601; H04L 51/046; G06Q 30/0201

(57) ABSTRACT

A system and method for collecting and selling the personal contact information of users matched based upon responses to a user survey is provided. The system involves users completing a survey that is designed to gauge and categorize certain characteristics and preferences of each user. Upon completion of the survey, users also provide their personal contact information and agree to have their contact information disclosed, for a fee, to other users who have also completed the same survey with compatible results. Based on the survey results of each individual user, users are matched with other individual users whose survey results are compatible with their own. Users are then notified of any compatible match and are allowed to purchase the contact information of any matching compatible users.

### CROSS-REFERENCES TO RELATED APPLICATIONS

Not Applicable

### STATEMENT REGARDING FEDERALLY SPONSORED RESEARCH AND DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR A JOINT INVENTOR

Not Applicable

### BACKGROUND OF THE INVENTION

### (1) Field of the Invention

The invention relates generally to the fields of matchmaking, online dating, and employment services. More particularly, the invention relates to a system and method for allowing users to identify other compatible users based upon a customized criteria designated through the users' survey responses, and allowing users to purchase the personal contact information of their compatible matches for a fee.

### (2) Description of Related Art

Various methods of matchmaking, dating services, and employment services have existed for thousands of years. More recently, the internet has provided a new forum for matchmaking via online dating, social networking, as well as online employment services. Most currently available forms of online dating require users to create a profile page that is subsequently viewed by other users, followed by users socializing and pursuing relationships as they see fit. However, this requires a significant amount of time and effort to be set forth by each individual user, generally with limited direction or assistance with the process of identifying and contacting a specific potentially compatible romantic partner.

It would therefore be desirable to provide a method of matchmaking that does not require as much time and effort on the user's part, yet still provides users with the ability to identify and directly contact potentially compatible romantic partners based on each user's unique individual characteristics and preferences. Similarly, it would also be desirable to provide a method of matching users with compatible platonic friends, as well as compatible employers and job applicants as a form of employment services.

### BRIEF SUMMARY OF THE INVENTION

The invention is a system and method for collecting and selling the personal contact information of users matched together based upon mutually satisfactory user responses to a survey. The system involves users completing a survey that is designed to gauge and categorize certain characteristics and preferences of the user. Upon completion of the survey, the user also provides their personal contact information and agrees to have their contact information disclosed to other users who have also completed the same survey with compatible results. Based on the survey results of each individual user, users are matched with other individual users whose responses to each survey question are compatible with their own. Users are then able to purchase the contact information of other compatible users for a fee. The invention thereby allows users to identify and, for a fee, directly contact potentially compatible individuals that match the user's designated criteria, all with minimal time and effort required on the part of each user.

### BRIEF DESCRIPTION OF THE VIEWS OF THE DRAWINGS

Not Applicable

### DETAILED DESCRIPTION OF THE INVENTION

The following description sets forth the preferred embodiments, in accordance with the present invention, of a system and method for collecting and selling the personal contact information of compatible users matched together based upon mutually satisfactory user responses to a survey. The survey questions vary based on the particular form of matchmaking that is desired by the user.

In one embodiment of the invention, the survey questions relate to personal characteristics as well as user preferences as they relate to a user's ideal romantic partner. User responses to the survey questions are stored electronically and utilized to match the user with other users whose responses are deemed compatible, based on each user's unique characteristics and preferences determined based upon the user's survey responses. Compatibility requires both matched users to answer each survey question in the specific manner which the other user designates through his or her own survey responses. Users must also provide their personal contact information and agree to have their personal contact information sold to compatible users that elect to purchase their contact information, and users must also agree to hold the entity selling the contact information harmless from any liability or dissatisfaction with the outcome of any future relationships between users. When a compatible match of two users is identified, compatible users are notified via an individual e-mail message to each user, and users are allowed to purchase the personal contact information of the other compatible user for a fee.

In this embodiment of the invention the survey is designed to identify compatible romantic partners for individuals that take the survey. The survey questions include but are not limited to most or all of the following topics:
1. Sexual orientation of user.
2. Ethnic background of user and their preferred ethnic background for a romantic partner, if any.
3. Religious identity of user and their preferred religious identity for a romantic partner, if any.
4. Relationship goals of the user.
5. Age of the user and their preferred age range for a romantic partner, if any.
6. Family Plans of the user.
7. Geographic location of the user and their preferred geographic location for a romantic partner, if any.
8. Financial Status of the user and their preferred financial status for a romantic partner, if any.
9. Height of the user and their preferred height range for a romantic partner, if any.
10. Political views of the user and their preferred political views for a romantic partner, if any.

In another embodiment of the invention, the survey is designed to identify compatible platonic friendships for individuals that take the survey. The survey questions include but are not limited to most or all of the following topics:
1. Sex of user and the preferred sex of a friend, if any.
2. Ethnic background of user and their preferred ethnic background of a friend, if any.
3. Religious identity of user and their preferred religious identity of a friend, if any.
4. Preferred activities the user would be interested in doing with a friend.
5. Age of the user and their preferred age range of a friend, if any.
6. Geographic location of the user and their preferred geographic location of a friend, if any.

In another embodiment of the invention, the survey is designed to identify compatible employers and job applicants that take the survey. The survey questions include but are not limited to most or all of the following topics:
1. The job type available for employers and the job type desired for job applicants.
2. The education level required for the available position and the education level of the job applicant.
3. The work experience required for the available position and the work experience level of the job applicant.
4. Whether the available position is full time or part time, and whether the job applicant is looking for full time or part time employment or either.
5. The salary offered for full time employment or the hourly wage offered for part time employment, and the salary or hourly wage expected by the job applicant.
6. Geographic location of the available position and the geographic location that the job applicant is willing to work in.

In all embodiments of the invention with varying survey questions described herein, the system and method described above for the collecting and selling of the personal contact information of compatible users remains the same. However, it should be noted that various modifications may be made to the preferred embodiments described herein. All such variations are intended to be included within the scope of this disclosure.

What is claimed is:

1. A system for collecting and selling the personal contact information of users, matched together based upon mutually satisfactory user responses to a survey, comprising of:
a. means for presenting each user with a set of survey questions designed to gauge certain characteristics and preferences of each user
b. means for recording each user's responses to the survey questions
c. means for requesting the personal contact information of all users
d. means for recording each user's personal contact information
e. means for requesting a disclaimer from each user for a release of liability associated with the disclosure of their personal contact information
f. means for matching users with other users based upon mutually satisfactory user responses to a set of survey questions
g. means for sending an electronic mail notification to users who have been identified as compatible users
h. means for offering for sale to users the personal contact information of other users that are identified as a compatible match to the user

2. The method of claim 1, wherein the user is presented with a set of survey questions comprising of topics including but not limited to sexual orientation, ethnic background, religious identity, relationship goals, age, family plans, geographic location, financial status, political views, and/or preferred activities.

3. The method of claim 1, wherein the user is presented with a set of survey questions comprising of topics including but not limited to job type, education level, work experience level, job payment level, and geographic location.
